(19) United States
(12) Patent Application Publication
(10) Pub. No.: US 2006/0234642 A1
(43) Pub. Date: Oct. 19, 2006

(54) LOW FEEDBACK SCHEME FOR LINK QUALITY REPORTING BASED ON THE EXP ESM TECHNIQUE

(75) Inventors: Kevin L. Baum, Rolling Meadows, IL (US); Yufei W. Blankenship, Streamwood, IL (US); Brian K. Classon, Palatine, IL (US); Mark C. Cudak, Rolling Meadows, IL (US); Philippe j. Sartori, Algonquin, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/275,962

(22) Filed: Feb. 7, 2006

Related U.S. Application Data
(60) Provisional application No. 60/661,457, filed on Mar. 14, 2005.

(51) Int. Cl. H04B 17/00; H04B 7/00

(52) U.S. Cl. 455/67.13; 455/69

(57) ABSTRACT

A method for providing a low-feedback scheme for link-quality reporting based on the EESM technique is provided herein. During operation, a node will analyze the current channel conditions and determine a non-linear approximation of the carrier to interference plus noise ratio (CINR). The non-linear approximation is sent to a communication unit as a channel-selectivity report, causing the communication unit to utilize the report to assist with modulation and coding selection.

### FIELD OF THE INVENTION

The present invention relates generally to low feedback link quality reporting and in particular, to a method and apparatus for a communication system to provide a low-feedback scheme for link-quality reporting based on the EXP-ESM technique.

### BACKGROUND OF THE INVENTION

In the IEEE C802.16e-05/141, “CINR measurements using the EESM method,” by Alvarion Ltd, (Mar. 2005), a modification of the signal to noise ratio (SINR) reporting process is proposed in order to use the Exponential Effective Signal to Interference Ratio (SIR) Mapping (EESM) method. Recent publications have shown that the EESM method is a very useful method to predict the frame error rate (FER) for multicarrier modulation systems in a frequency selective channel. Using the EESM method for link adaptation has the potential to significantly improve system performance: as illustrated by Alvarion, the prediction error with the EESM is lower than 1 dB, whereas the prediction error using only the mean SNR typically ranges between 3 dB and 6 dB (and in some cases the error is much larger). It is therefore expected that a properly configured EESM estimator will improve the system capacity given that currently the standard uses the average SINR based method.

The simplified version of the EESM solution appears to be based on an assumption that the relationship between the effective SNR (dB) and β (dB) is linear over a range of β (dB) values, where β comprises a parameter whose value is chosen in order to minimize the prediction error of the EESM method. This assumption is quite limited, especially for practical frequency-selective channels. Therefore, a need exists for a method and apparatus for providing a low-feedback scheme for link-quality reporting based on the EESM technique having better estimation accuracy over a wider range off β values.

### BRIEF DESCRIPTION OF THE DRAWINGS

FIG. 1 illustrates simulation results for a single-channel realization.

FIG. 2 shows the effective SNR vs. β for Rayleigh fading and a lower average SINR of 6 dB.

FIG. 3 and FIG. 4 depict the effective SNR (dB) as a function of β (dB) for the Ped A channel, for an average SINR of 10 dB and 5 dB, respectively.

FIG. 5 and FIG. 6 show fading channel curves.

FIG. 7 is a flow chart showing operation of a communication system.

### DETAILED DESCRIPTION OF THE DRAWINGS

In order to address the above-mentioned need, a method for providing a low-feedback scheme for link-quality reporting based on the EESM technique is provided herein. During operation, a node will analyze the channel conditions and determine a non-linear approximation of the carrier-to-interference plus noise ratio (CINR) vs. β dependency. (the terms ‘Signal to Interference-plus-Noise Ratio (SINR)’, ‘Carrier to Interference-plus-Noise Ratio (CINR)’ and ‘Signal to Noise Ratio (SNR)’ are used as synonyms). The parameters of the non-linear approximation are sent to a communication unit as a channel-selectivity report, causing the communication unit to utilize the parameters to assist with modulation and coding selection. Because a non-linear approximation is utilized, the relationship between the effective SNR (dB) and β is more closely approximated.

The present invention encompasses a method for channel-selectivity reporting. The method comprises the steps of analyzing a channel condition, and determining a quadratic approximation of carrier to interference plus noise ratio (CINR) in dB vs. β_{dB}. The quadratic approximation is represented as an effective CINR_{dB}(β_{dB})=a+bβ_{dB}+cβ_{dB}², where a, b, and c are the Y-intercept, linear, and quadratic parameters, respectively. Finally, the parameters of the quadratic approximation are sent to a base station as a channel-selectivity report.

The present invention additionally encompasses a method for channel-selectivity reporting. The method comprises the steps of analyzing a channel condition and determine a non-linear approximation of carrier to interference plus noise ratio (CINR) vs. β. The non-linear approximation is represented as an effective CINR(β)=F(β). The parameters of the non-linear approximation are sent to a communication unit as a channel-selectivity report.

In IEEE C802.16e-05/141, a linear dependency between the effective SNR (dB) and β (dB), β<15 dB, is hypothesized. However, this hypothesis is based on observations over a very limited set of simulation conditions. The example given in the document assumes that the channel is independently Rayleigh faded on every subcarrier and the only SNR considered is 10 dB.

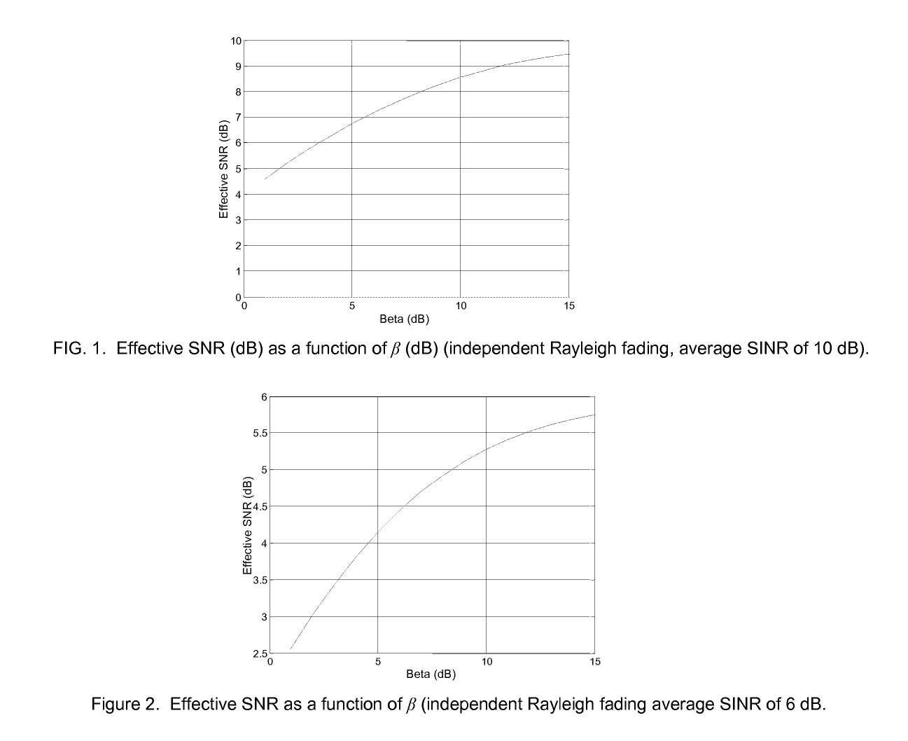

In the following discussion, various channel types were studied to check the validity of the linear assumption. The plots are shown with β in the range of 0 dB to 15 dB, since for modulation and coding schemes defined in the standard, the β value (linear) ranges roughly from 1 (close to β of QPSK, rate ½) to 30 (close to β of 64-QAM, rate ¾). As a check of our simulation setup, we first show our simulation results with exactly the same assumptions for a single channel realization in FIG. 1. (In order to make the figures easy to read, only a single channel realization is presented on each plot. The channel sample was chosen randomly and is representative of the channel conditions one might expect for a given channel type). As it can be observed from FIG. 1, a more or less linear dependency is observed up to a β value of 15 dB, although there is some degradation for β larger than 9 dB.

However, it should first be noted that the range on which the linear approximation is valid is fairly limited. As an example, FIG. 2 shows the effective SNR vs. β for Rayleigh fading and a lower average SINR of 6 dB. These results show an approximately linear relationship for a small region of β between 1 dB and 5 dB. When considering β>5 dB region as well, the nonlinearity can not be ignored.

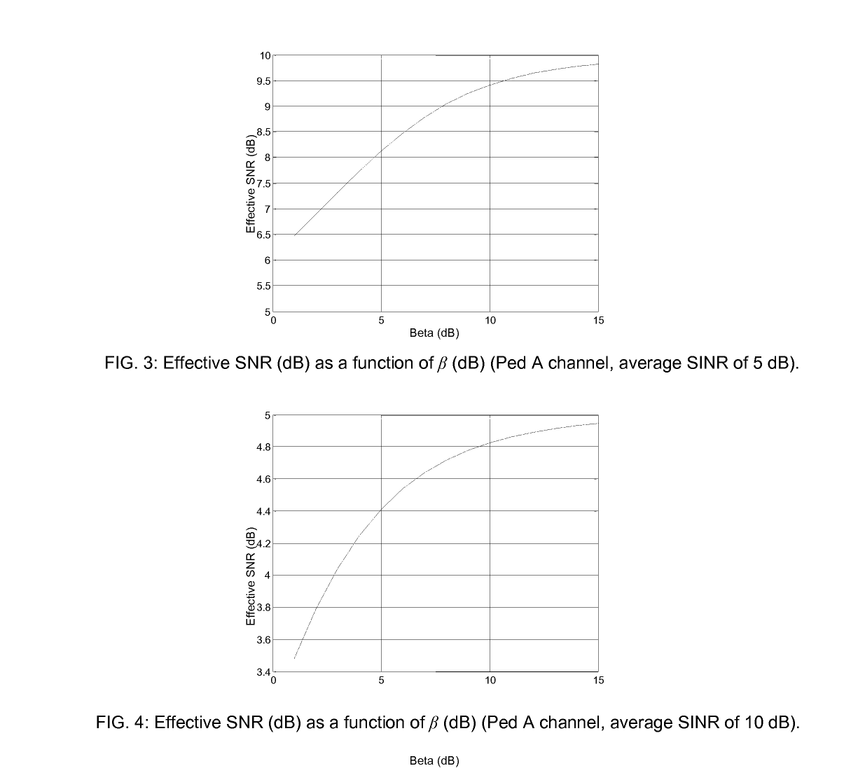

Next, we investigate the characteristics over a more realistic channel model rather than the artificial model used above. In practice, the frequency response of the channel is correlated over several subcarriers. It is therefore important to look at the effective SNR vs. β for channels having such correlation. One channel often used for the 3G evaluation is the 3GPP Pedestrian A (Ped A) channel. FIG. 3 and FIG. 4 depict the effective SNR (dB) as a function of β (dB) for the Ped A channel, for an average SINR of 10 dB and 5 dB, respectively.

Clearly, for the Ped A channel, it is inaccurate to consider that the dependency between the effective SNR and β (dB) is linear for the entire range of 0 dB<β<15 dB. For instance, for a received average SINR of 10 dB, the curve appears linear only over a couple of dB at a time. For a system like IEEE 802.16 where 16-QAM and 64-QAM are defined, the β difference for two consecutive Modulation/Coding Schemes (MCS) is larger than 2 dB. Thus, though the EESM method is promising for improving MCS selection, the feedback method should be improved to provide better accuracy over a wider range of β values.

The method presented above can easily be generalized by using a better curve fitting. First, from link-level simulations (not presented here), it appears that the [0 dB, 15 dB] range for β is sufficient to cover modulation levels up to 64-QAM for the coding schemes used by IEEE 802.16e. Therefore, the focus of the curve fitting will be the [0 dB, 15 dB] range.

Although many types of curve fitting, SNR_{eff}=F(β) where F(β) is an nonlinear function of β, could be used in theory, it is necessary to limit the amount of feed back the mobile has to send to the BS. As an example of the function F(β), a quadratic curve fitting can be employed to provide very good accuracy. The SNR_{eff} (dB)-β (dB) relationship can be approximated by:
SNR_{eff}(dB)=a+bβ_{dB}+c β_{dB}², (1)

Where a, b, and c are coefficients that need to be determined for the current channel realization or channel condition. Note that, when compared to the linear method, only one additional coefficient is needed. Note also that a is the effective SNR value for β=0 dB (i.e., β=1). Obviously, a different reference point for β could be chosen.

These three parameters, a, b and c may vary at a different rate. For instance, a varies at the same rate as the instantaneous CINR (with different amplitude), whereas link simulations have shown that b and c are heavily dependent on the channel type, but do not necessarily vary significantly for two different realizations of the same channel type. Thus, it is more efficient to send a more frequently (for instance using a CQI report), and b and c at a slower rate. Alternatively, a simpler but less efficient approach is to send these three coefficients in every CQI report.

In addition, only three variables of the four, {SNR_{eff}, a, b, c} need to be provided to fully construct the relationship of (1), if the β value is known. Thus variations of the protocol based on (1) can be used. For example, {SNR_{eff}, b, c} may be sent back from the subscriber to the basestation instead of {a, b, c}, while a is derived based on (1). In this case, {b, c} can be updated less frequently than {SNR_{eff}} .

It should also be noted that although the curve fitting function above focus on approximating the relationship of SNR_{eff} (dB)−β (dB), it is equivalently valid to approximate the relationship of SNR_{eff} (dB)−β (linear scale), or SNR_{eff}(linear scale)−β (dB).

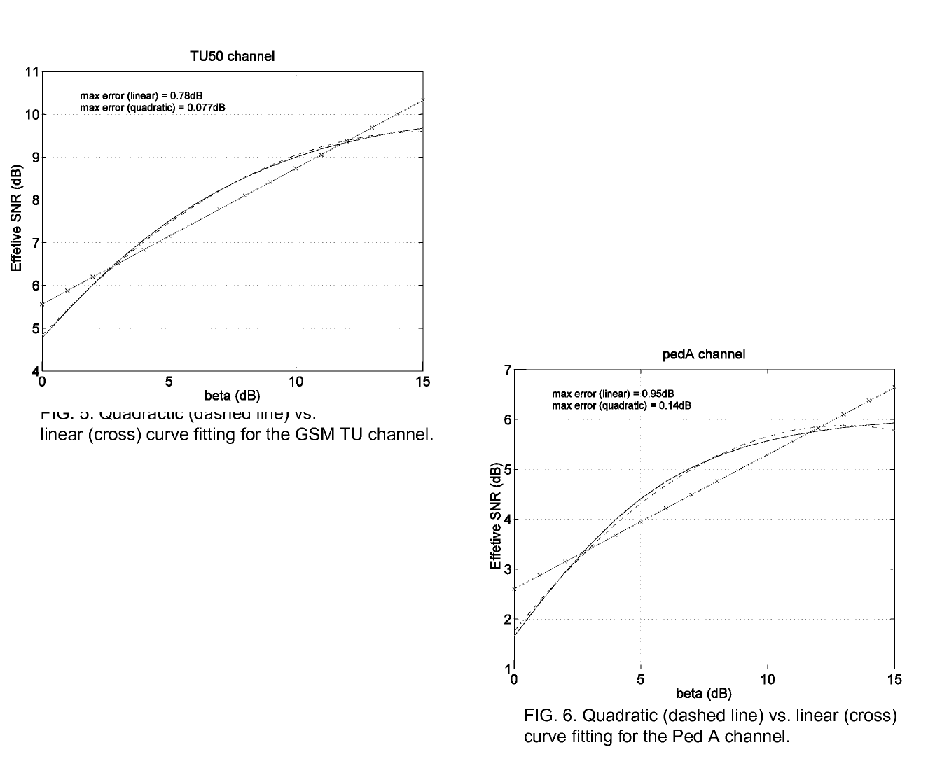

The fading channel curves shown in FIG. 5 and FIG. 6 illustrate that the quadratic approximation is more accurate than the linear approximation in the β (dB) range of interest. In fact, the quadratic approximation leads to an almost perfect curve fitting (a few hundredths of a dB, not noticeable when practical limitations are taken into account). It is important to minimize the curve-fitting error, because this easily controllable error is in addition to the EESM method error which is very difficult to further reduce. Since the EESM method error is less than 0.5 dB for all the IEEE 802.16 MCS, the advantage of using EESM will be lost if the curve-fitting error is more than a fraction of 0.5 dB.

Note that in FIG. 5 and FIG. 6, the slope of the linear approximation was selected to minimize the mean-square error (under the linear curve constraint) over the entire β range of [0 dB, 15 dB]. If the slope local to a specific β value was used instead (as suggested in IEEE C802.16e-05/141), then errors on the order of several dBs may occur.

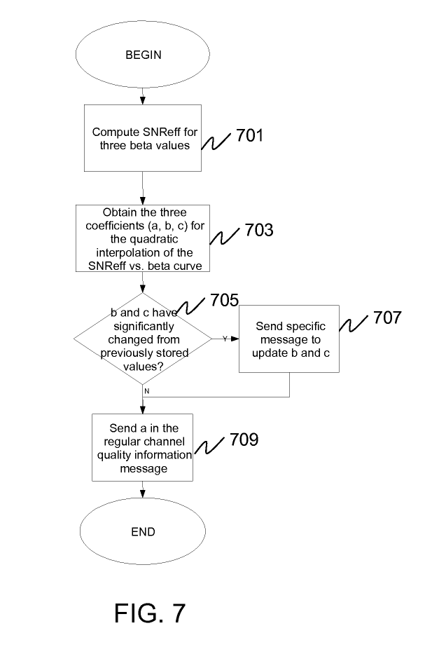

FIG. 7 is a flow chart showing operation of a communication system described above. It is assumed that the mobile has previously communicated b and c values (bₛₜₒ and cₛₜₒ) to the base. If such values have not been communicated, it is assumed that bₛₜₒ and cₛₜₒ are initialized to a given value, known by both the mobile and the base.

Using its current channel conditions (analyzed with any prior art technique such as pilot-based channel estimation), the subscriber station computes SNR_{eff} vs. β values (say 0 dB, 6 dB, and 12 dB). (step 701) The subscriber station performs a quadratic interpolation of the SNR_{eff} vs. β and obtains parameters a, b, and c from equation (1). (step 703). The subscriber determines if b and c have drifted by more than a given tolerance from bₛₜₒ and cₛₜₒ, set bₛₜₒ=b and cₛₜₒ=c (step 705) and sends a message to the base with the new bₛₜₒ and cₛₜₒ (step 707) if b and c have drifted. Finally, the subscriber sends a in the regular channel quality information message (step 709).

At the base station, the process is even simpler. The base needs to have a lookup table with the β value for all Modulation and Coding Schemes (MCS), coding types (e.g., convolutional turbo code), information frame size, required QoS, etc. The base gets the a, b and c parameters from the mobile and can reconstruct the SNR_{eff} vs. β curve. Using the lookup table, the base is able to get the SNR_{eff} for each MCS. From the SNR_{eff} value, the base can obtain the expected FER with the AWGN curve using the method described in [2] and [3]. The base can then select an MCS by, for instance, picking up the base MCS with a FER below a given target (e.g., 10%).

The following text shows the changes necessary to IEEE C802.16 in order to practice the above steps.

[Add the following entries to table 14, page 34:]

| Type | Message name | Message description | Connection |
|---|---|---|---|
| ... | | | |
| 66 | CINRMODE_REQ | CINR measurement | Basic |
| | | mode change request | |
| | | message | |
| 67 | CINRMODE_RSP | CINR measurement | Basic |
| | | mode change response | |
| | | message | |
| 68-255 | | Reserved | |

[Add the following new section 6.3.2.3.63:]

.3.2.3.63 CINR measurement mode change request (CINRMODE_REQ) message The BS may decide to change the CINR measurement mode of an MSS that supports EESM CINR measurement by sending a CINRMODE_REQ message, to which the MSS shall respond with a CINRMODE_RSP message. This message only applies to OFDMA PHY mode.

TABLE
WWW - CINRMODE_REQ message format

| Syntax | Size | Notes |
|---|---|---|
| CINRMODE_REQ { | | |
| Management Message | | |
| Type=66 | 8 bits | |
| CINR measurement mode | 1 bit | 0b0-Regular CINR measurements |
| | | 0b1-EESM CINR measurements |
| If (CINR measurement | | |
| mode ==0b1) | | |
| { | | |
| CINR reference FEC type | 2 bits | Indicates the FEC type for which th [symbol] |
| | | normalized C/N and β values apply |
| | | 0b00=CC |
| | | 0b01=CTC |
| | | 0b10=BTC |
| | | 0b11=LDPC |
| Information data bytes | 8 bits | Indicates the number of informatio [symbol] |
| | | data bytes a packet carries |
| } | | |
| Start_frame | 7 bits | 6 LSBs of the frame number i [symbol] |
| | | which the new measurement mode i [symbol] |
| | | activated |
| } | | |

CINR Measurement Mode
Indicates the new measurement mode that is activated from the frame specified by ‘start frame’ field. The MSS shall reset all message time indices related to CINR measurement (see sections 8.4.11.3 and 8.4.11.4) upon activation of the new CINR measurement mode.
[Add the following new section 6.3.2.3.64]

6.3.2.3.64 CINR measurement mode change response (CINRMODE_RSP) message The CINRMODE_RSP message shall be used by the MSS to acknowledge receipt of the CINRMODE_REQ message and to send relevant parameters. The MSS shall send its response prior to the frame number in which the new measurement mode is activated, as specified in the ‘start frame’ field of the received CINRMODE_REQ message. The MSS may also send a CINRMODE_RSP message in an unsolicited fashion to notify the BS of a change in the CINR vs. [symbol] curve fitting parameters.

TABLE
UUU - CINRMODE_RSP message format

| Syntax | Size | Notes |
|---|---|---|
| CINRMODE_RSP | | |
| message format { | | |
| Management Message Type-67 | 8 bits | |
| Linear β parameter | 8 bits | Curve fitting parameter for th [symbol] |
| | | CINR (dB) vs. [symbol] (dB) curve. Se [symbol] |
| | | section 8.4.11.4. |
| Quadratic β parameter | 8 bits | Curve fitting parameter for th [symbol] |
| | | CINR (dB) vs. [symbol] (dB) curve. Se [symbol] |
| | | section 8.4.11.4. |
| } | | |

[Add the following new section 8.4.11.4]
.4.11.4 Optional EESM CINR measurement mode The EESM method for computing effective CINR provides the BS with a tool to better estimate the optimal MCS and/or boosting level for the MSS by accounting for the frequency selectivity of the signal and the noise. The BS may switch the CINR measurement mode of the MSS to EESM by sending a CINRMODE_REQ message. Following activation of this mode, CINR mean shall be computed using the EESM method.
CINR_{β}=EESM [{γ₁, . . . ,γ_{N}},β]
where

$$EESM [ \{ {γ}_{1} , … , {γ}_{N} \} , β ] = - β \cdot ln ( \frac{1}{N} {\sum }_{i = 1}^{N} exp ( - \frac{{γ}_{i}}{β} ) ) , \\ \{ {γ}_{1} , … , {γ}_{N} \}$$

are the set of per-subcarrier CINR values (in linear scale) and β is a weighting coefficient in linear scale. In addition, the MSS shall compute the quadratic approximation of CINR vs. β_{dB}=10 log (β) and update its parameters using the CINRMODE_RSP message according to the following procedure. After the quadratic curve fitting, CINR can be approximated as:
CINR_{β}(dB)=a+bβ_{dB}+cβ_{dB}²
In Table UUU, parameter b is called the ‘linear β parameter’ and c is the ‘quadratic β parameter’. Parameters b and c are sent in the CINRMODE_RSP message. Parameter a=CINR₀ is reported in the CQI_feedback. The method to determine b and c are left to individual implementation. The CINR value shall not include the SNR improvement resulting from repetition. The reported CINR shall include all receiver implementation losses. When a linear approximation is good enough, the MSS shall set the quadratic β parameter c to 0.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for channel-selectivity reporting, the method comprising the steps of:
analyzing a channel condition;
determining a quadratic approximation of carrier to interference plus noise ratio (CINR) in dB vs. β_{dB}, wherein the quadratic approximation is represented as an effective CINR_{dB}(β_{dB})=a+bβ_{dB}+cβ_{dB}², wherein a, b, and c are the Y-intercept, linear, and quadratic parameters, respectively;
sending the parameters of the quadratic approximation to a base station as a channel-selectivity report.

2. The method of claim 1 further comprising the step of:
receiving a request from the base station to send the parameters of the quadratic approximation to the base station, and sending the parameters of the quadratic approximation in response to the request.

3. The method of claim 1 further comprising the step of:
at a time after sending the parameters of the quadratic approximation, determining that at least one of parameters a, b, or c has substantially changed; and
sending at least one of parameters a, b or c when at least one of a, b or c has changed.

4. The method of claim 1 further comprising:
at a time after sending the parameters of the quadratic approximation, determining an updated value of at least one of a, b, or c; and
sending the updated value of at least one of a, b, or c.

5. The method of claim 1 where the value of parameter a is sent indirectly as an effective CINR value for a known β value, CINR_{dB}(β_{dB}).

6. The method of claim 1 wherein the step of analyzing the channel comprises computing an effective CINR for each of a plurality of β values and wherein the step of determining a quadratic approximation is further based on the plurality of computed effective CINR values.

7. The method of claim 1 wherein the step of sending the parameters of the quadratic approximation to the base station comprises the step of sending the parameters of the quadratic approximation to the base station, wherein the base station utilizes the parameters to assist with modulation and coding selection.

8. A method for channel-selectivity reporting, the method comprising the steps of:
analyzing a channel condition;
determining a non-linear approximation of carrier to interference plus noise ratio (CINR) vs. β, wherein the non-linear approximation is represented as an effective CINR(β)=F(β);
sending parameters of the non-linear approximation to a communication unit as a channel report.

9. The method of claim 8 wherein the step of determining the non-linear approximation comprises the step of determining a quadratic approximation.

10. The method of claim 9 wherein the step of determining the quadratic approximation comprises the step of determining the quadratic approximation in dB.

11. The method of claim 10 wherein the step of determining the quadratic approximation in dB comprises the step of determining CINR_{dB}(β_{dB})=a+bβ_{dB}+cβ_{dB}², wherein a, b, and c are the Y-intercept, linear, and quadratic parameters, respectively.

12. The method of claim 11 where Y-intercept of the non-linear function is sent indirectly as an effective CINR value for a known β value, CINR_{dB}(β_{dB}).

13. The method of claim 8 wherein the step of determining the quadratic approximation comprises the step of determining the quadratic approximation in dB.

14. The method of claim 8 further comprising the step of:
receiving a request from the base station to send the parameters of the non-linear approximation to the base station; and
sending the parameters of the non-linear approximation in response to the request.

15. The method of claim 8 further comprising the step of:
determining that the non-linear parameters have changed; and
the step of sending the parameters of the non-linear approximation comprises the step of sending the parameters of the non-linear approximation when the non-linear parameters have changed.

16. The method of claim 8 further comprising the step of:
at a time after sending the parameters of the non-linear approximation, determining that at least one of parameters of the non-linear approximation has substantially changed; and
sending at least one of parameters of the non-linear approximation when at least one of the parameters of the non-linear approximation has changed.

17. The method of claim 8 further comprising:
at a time after sending the parameters of the non-linear approximation, determining an updated value of at least one of the parameters; and
sending an updated value of at least one of the parameters.

18. The method of claim 8 wherein the step of sending the parameters of the non-linear approximation to the communication unit comprises the step of sending the parameters of the non-linear approximation to a base station.

19. The method of claim 8 wherein the step of sending the parameters of the non-linear approximation to the base station comprises the step of sending the parameters of the non-linear approximation to the base station, wherein the base station utilizes the parameters to assist with modulation and coding selection.

20. The method of claim 8 wherein the step of sending the parameters of the non-linear approximation to the communication unit comprises the step of sending the parameters of the non-linear approximation to the communication unit, wherein the communication unit utilizes the parameters to assist with modulation and coding selection.
